(19) United States
(12) Patent Application Publication
(10) Pub. No.: US 2007/0085325 A1
(43) Pub. Date: Apr. 19, 2007

(54) Expandable notebook or portfolio

(76) Inventor: Mary EB Smith, Charlotte, NC (US)

Correspondence Address: Mary EB Smith, PO Box 34483, Charlotte, NC, 28234, US

(21) Appl. No.: 11/234,854

(22) Filed: Sep. 26, 2005

(51) Int. Cl. B42D 1/00

(52) U.S. Cl. 281/20

(57) ABSTRACT

An expandable notebook for retaining and displaying papers or other materials includes a binder having a pair of decorative front and back covers connected to each other by an expandable spine. The spine is made of a plicated material for expansion and contraction, and has opposing slots on each side for receiving flexible, self-locking retainer straps which are adjustable for retaining various thicknesses of material. In a preferred embodiment each retainer strap is mounted through a pair of opposing slots formed on each side of the plicated spine, thereby surrounding the spine, and when locked in place the strap forms an adjustable loop which lies between the inner surfaces of the covers, to accommodate varied thicknesses of bound material within the loop and protected within the binder covers.

### BACKGROUND OF THE INVENTION

The retention and protection of groups of papers or other sheet material by containing in files, notebooks, folders, portfolios, and the like has evolved from the use of simple file folders, ring binders, and permanently bound photograph albums and scrapbooks, to the need for more sophisticated and customized approaches. This evolution has been fueled by the increased creativity of individuals who are, many for the first time, in possession of the home publishing capabilities and artistic potential of the home computer. Software development enables the professional and the nonprofessional to compose, draft, design, and publish these works in their own homes and small businesses. However, the technology of addressing the physical requirements of binding a self-published book, or creating and preserving one's artistic portfolio in a professional manner has not kept pace.

In recent years there have been attempts at creating various types of ring binders which would allow some adjustment in content and thickness of the materials bound therein. Many of these designs have come from the sales divisions of industries such as printing, paper products, fabric manufacturers, where it is necessary for sales personnel to carry large number of sheet-form samples, display the samples, and frequently edit the content of the sample display as new products are developed or discontinued. At the consumer level In recent years there has been a tremendous surge in the market for decorative portfolios, binders, and folders which are not only attractive, but which are adjustable to accommodate various capacities of bound material. This consumer market also demands the provision of such items in widely varying sizes. For example, one embodiment might be the cover for an original, multi-page greeting card to be placed within an envelope for mailing; or another embodiment may be as large as a family album or scrapbook. Still further, an artist or designer might choose to keep large samples of original art, architectural drawings and renderings, or large fabric swatches in a portfolio that is attractive and which may be easily expanded as the portfolio grows.

The present invention in its preferred embodiment described below enables the economic production and individualization of these widely varied portfolios, scrapbooks, greeting cards, or utilitarian files. A binder made according to the present invention might have an exterior appearance of being professionally made, but which may be individually designed, compiled, and repeatedly adapted to the needs of the end user. To accommodate a variety of designs, the front and back covers of the binder are connected to each other by a flexible, scored spine; or alternatively by a plicated, width-adjustable spine; each designed to expand or contract as needed, and each of which supports the unique adjustable retainer straps. The spine ultimately conceals the bound edges of the sheet material contained within the binder and held by the retaining straps.

Binder construction as described below eliminates the old processes of sewing, gluing, or otherwise binding books, pamphlets, and the like, as these processes are prohibitive in cost for individuals who desire production of small quantities or single, customized items. The invention is also fully applicable to production of large numbers of binders, folders, or portfolios to reach a less customized market. As described below, the individual components of the binders may, when the market demands, be sold separably in some environments, allowing for replacement of damaged parts, or for changing the aesthetic design of the binder covers.

In one preferred embodiment each of the unique retainer straps is mounted in a pair of slots, which are positioned in opposing relationship to each other, in or on side extremities of the spine. In one embodiment described below, the slots are formed within the area of the spine, and it is in this embodiment that preference is given to forming the binder in one continuous piece. This binder includes a scored spine fully described below. Scoring enables flexibility and conforms substantially to the capacity of the retainer straps inserted therethrough. In this particular embodiment, there would be no slippage of the contained material into the area of the spine. The scored spine would be particularly desirable in the use of smaller models of the binder, such as personal notebooks, scrapbooks, or greeting cards. There is a somewhat limited expandability in the scored embodiment, but it allows for a range of adjustment to the capacity of the retaining straps.

In another preferred embodiment there are narrow, flat extremities extending the length of and parallel to the spine plicates, such that each of these extremities creates a narrow shoulder which is integral to the edge of the plicated spine. These shoulders are non-plicated, lateral extensions of the spine, and are formed of a rigid material having sufficient weight, thickness, and strength to support formation of apertures therein, and to support the adjacent front and back covers of the folder. The width of each shoulder and its material weight are determined by factors including the overall size of the finished folder, the weight and thickness of the front and back covers of the folder, and the required size of the slots to be formed in the shoulder. The size of each slot is generally determined by the overall width and thickness of the retainer strap that is required to support the estimated maximum thickness of the enclosed pages of sheet material. This particular embodiment is particularly suitable for use by engineers, artists, or fabric designers who can utilize the plicated spine for separation of the individual sheets of material contained in the binder. All of these factors will be defined in greater detail below in the description of preferred embodiments.

The unique retainer straps are adjustable from within either style of folder to accommodate the thickness of bound material. Each flexible retainer strap is formed of a elongated base strip made of plastic or other flexible material (such as a relative thin, flexible metallic) of uniform width and thickness. The strap includes a head member on one end which has an opening therethrough, a terminal end opposite the head member, and a plurality of spaced projections or knobs protruding perpendicularly from the base strip. The projecting knobs are physically designed to lock individually into the opening in the head member. Thus configured, the terminal end of the strap may be looped back through the head member, and a selected one of the projecting knobs locked into the head to form an adjustable loop for enclosing sheet material therein.

Examples of adjustable binders are demonstrated in previously issued U.S. Pat. Nos. 4,940,352, 4,990,017, 5,683,111, and 6,409,447, among others.

The following detailed description and drawings disclose preferred embodiments of the invention, wherein:

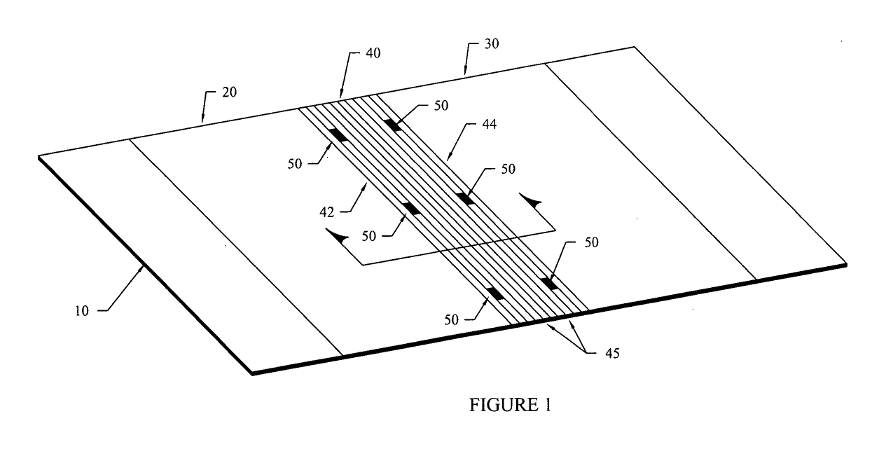

FIG. 1 is a view of one preferred embodiment of the invention whereby the binder is formed as a singular unit, and is shown in its opened position;

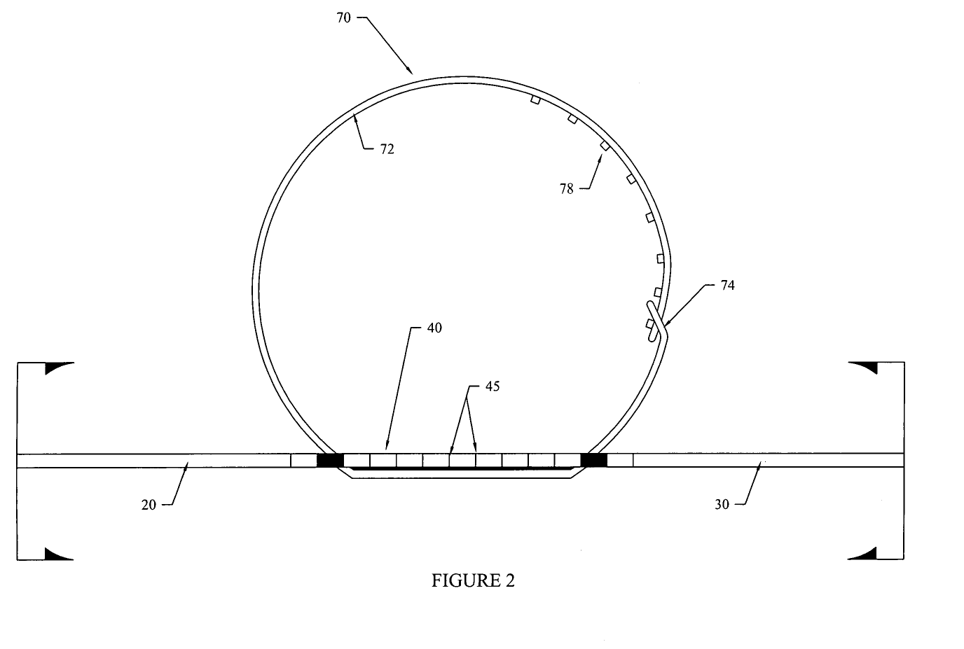

FIG. 2 is an enlarged sectional view of the embodiment shown in FIG. 1, illustrating the scored embodiment of the spine of the binder with the retainer strap positioned therein;

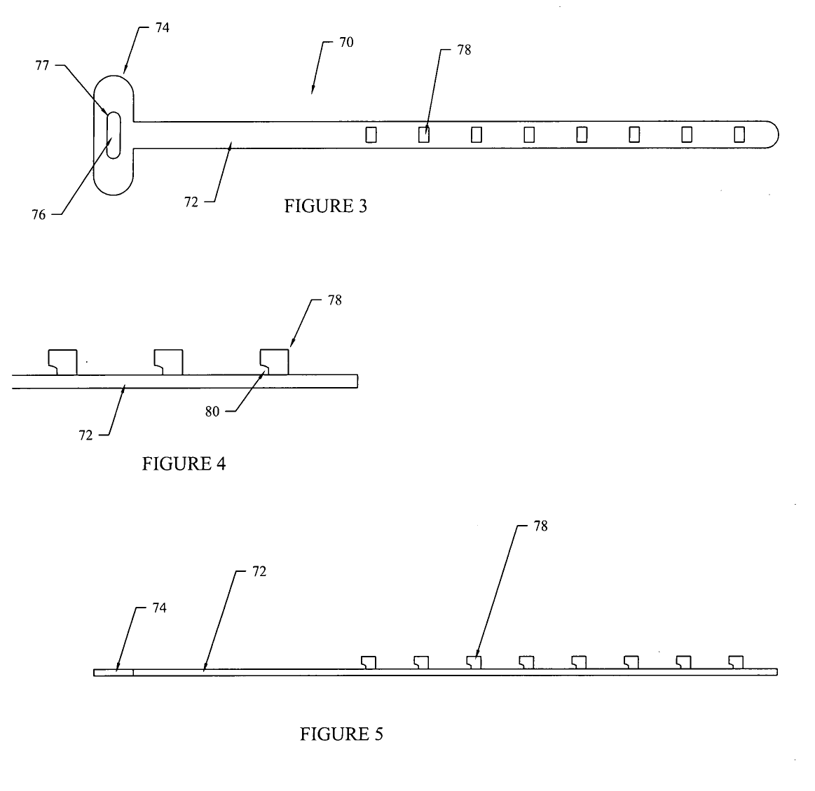

FIG. 3 is a plan view of a preferred embodiment of the retainer strap;

FIG. 4 is a cross-sectional view of the retainer strap of FIG. 3, showing in detail a preferred configuration of the projecting knobs;

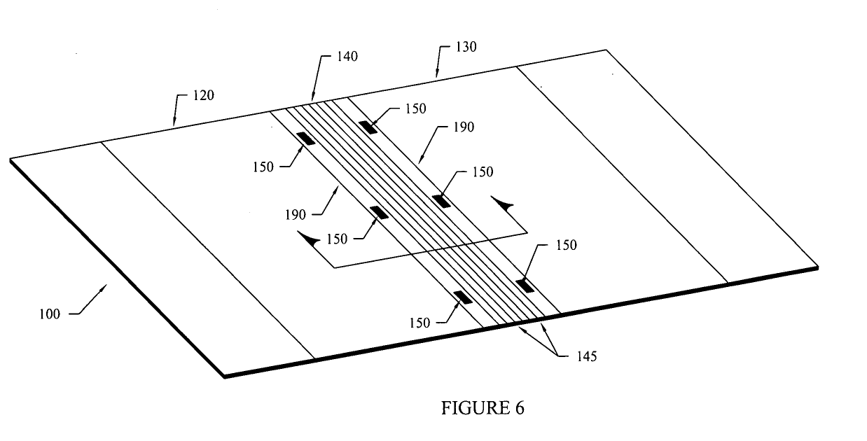

FIG. 5 is a side view of the retainer strap shown in FIG. 3;

FIG. 6 is a perspective view of an alternate preferred embodiment of the invention in its opened position;

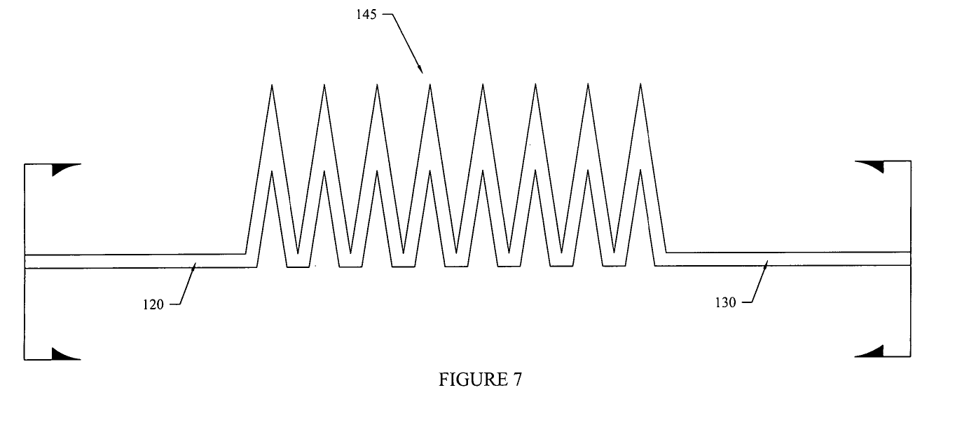

FIG. 7 is a detailed cross-sectional view of the plicated spine of the embodiment shown in FIG. 6; taken along lines A-A thereof, and

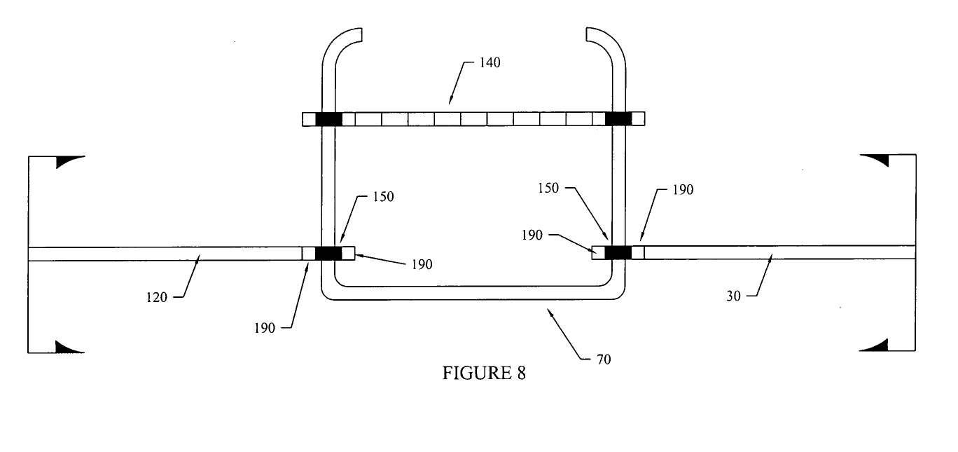

FIG. 8 is a detailed cross-sectional view of the binder of FIG. 6, illustrating the positioning of the retainer strap therein.

### A DETAILED DESCRIPTION OF A PREFERRED EMBODIMENT

It is appropriate through this entire description to remain aware that the binders may be of any decorative configuration desired. The decorative aspects of the product are not a part of the claimed invention and thus are not further described herein. Looking first at FIG. 1, the binder 10 is shown in its open, flat position and having a front cover 20, a back cover 30, and a connecting spine member 40. In this and other described embodiments, the front and back covers 20, 30, and the spine 40, are made from any of numerous materials which are known to be suitable for forming conventional notebooks and binders, and which have a rigidity suitable to the selected finished size and type. Some materials include the many varieties of plastic in selected weights, thicknesses, and range of flexibility. Other materials are not limited to, but include the wide variety of fiber board or foam board stocks traditionally used in construction of binders and books. For example, if a small binder such as might be used for a greeting card or pocket-sized book, the cover material would be of a relatively lighter weight and thickness than that which would be desirable in scrapbooks or larger binders. In these embodiments it is visualized that the cards or smaller binders may be formed of heavy decorative paper. On the other extreme, if the binder is to be utilized for holding large sheet material such as fabric or large paper samples, the cover material would of necessity be chosen from heavier, more rigid stock. In the embodiment of FIG. 1, the front and back covers and the spine are formed in a single contiguous piece of selected material. The covers 20 and 30 are identical in size and shape, and the desired finished size of the completed piece includes allowance for scoring the spine member 40. In this contiguous form, the spine 40 is submitted to a manufacturing process known as scoring, wherein lines are imprinted or embossed on the surface of the area in the center of the contiguous body. If desired, the area defining the spine 40, along lines 42 and 44, may be subjected to a coating material of choice, to strengthen the member 40 before the scoring process, and during use. The parallel scoring lines 45 are a prescribed distance apart, as determined during conventional manufacturing processes, by the finished size and end use of the binder. In addition to the plurality of scored lines 45, the spine 40 of this embodiment further includes pairs of opposing slots 50 formed therein. In most configurations each binder would require at least two pairs of the slots 50 but, as illustrated, some embodiments may require more. The slots 50 are formed in a size appropriate to receive the material retaining strap 70 and hold the strap with some limited movement therein. Although not shown in this application, it is recognized that in some large embodiments of the binder 10, if it is expected to be subjected to heavy use, the edges of the slots 50 may need to be reinforced by heavy protective coatings known to the industry; or in larger embodiments formed of fiber or similar materials, it may be necessary to overcast the edges of the slots by stitching.

Looking at FIG. 2, a section of the spine 40 as shown in FIG. 1 is shown with the preferred retaining strap 70 therein. The strap 70 has been threaded into a pair of opposing slots 50, in preparation for receiving selected sheet material (not shown). The retaining strap itself is best illustrated in FIGS. 3 through 5, and is used in either embodiment of binder 10. The retaining strap 70 is generally a flexible, self-locking strap for mounting in a described binder of choice. Each flexible retainer strap 70 is adjustable as described below, to accommodate various thicknesses of bound material, and generally is formed of a elongated narrow piece of plastic or similar flexible material, of substantially uniform width and thickness. Each strap includes a base strip 72 of uniform width and thickness of material; a head portion 74 on one end of the base 72, and an aperture 76 therethrough. A plurality of spaced, rounded projections or knobs 78 protrude perpendicularly to the base 72, and lock individually into the aperture 76 in the head 74 of the strap. Although it is preferred, and is illustrated, that the knobs 78 include a locking notch 80 integral to one side thereof, for receiving the inner edge 77 of aperture 76 therein, it is anticipated that in some embodiments this locking notch 80 would be unnecessary to the correct function of the invention.

For example, in a small, lighter weight embodiment such as a greeting card, the projecting knobs 78 could be formed with straight sides conforming in shape to that of the aperture 76, and held therein by friction. This would function because of the small amount of material to be contained within the strap 70, and the resulting lack of tension on the strap; which tension might cause the knob 78 to pop out of the aperture. However, in larger embodiments, holding heavier quantities of material therein, the notch 80 provides an increased level of protection against the know slipping out of the aperture and the strap opening.

Looking next at FIG. 6, a second but equally preferred embodiment, is shown. The binder 100 includes a front cover 120 and a back cover 130, connected by a spine 140. In this embodiment, the components 120, 130 and 140 may be formed integrally to each other as described in the embodiments of FIG. 1; or the components may be formed separately and joined together by the end user. Such a configuration would enable a great variety of decorative or functional forms of the invention, permitting the user to select from a variety of compatible materials, colors, designs and such, to form a purely individualized unit. This concept will function in smaller embodiments such as cards, small books, and the like, but is particularly useful in larger embodiments such as designated for holding large sheets of various types of material. The covers 120 and 130 may be formed of heavier board stock, covered in a variety of decorative materials. The spine 140 is of a compatible weight material which has a higher degree of flexibility, and the capacity to accept and hold a process of plication. The individual plicates 145 are best illustrated in FIG. 7, and are formed in the material of the spine 140, by a process applying a liquid form coating material followed by application of heat to set the plicates. This is similar to the process of applying starch or similar products to a textile material, followed by forming pleats therein and applying heat, to form apparel such as a pleated skirt or the like. In the present environment, however, the use of plication in a heavy fiber stock such as those known to bookbinders and similar artisans, provides a unit such as the spine 140 which will retain shape, flexibility, and function during long periods of heavy use. The plicates 145 also may be used to receive the bound individual edges of the retained sheet material therein, making the sheets easier to leaf through during use. This would be particularly desirable when carrying large sheets of fabric samples, or large drawings therein, while allowing them to be easily separated for viewing.

In this embodiment of FIG. 6, to further enable the expansion of the plicated spine 140 within the retaining strap 70, a pair of shoulder members 190 are utilized for support of the spine, by placing one shoulder member 190 parallel to and secured to the opposing edges 148 of the spine 140. This is illustrated in FIG. 8, in exploded view, showing the strap 70 inserted through the slots 150 formed in the shoulder members 190 and the material of the spine 140. In actual use, where material 140 is shown exploded away from the reinforcing shoulders 190, the edges of the material 140 is glued or otherwise adhered to the structure of the shoulders 190, and the slots 150 formed through both. This provides a strong edge support for application of the front and back covers thereto (not fully illustrated) and for support of the retaining straps 70 around the outside surface of the plicates 145.

Other and further embodiments of the invention are anticipated and the invention is limited only by the claims below.

What is claimed is:

1. A device for enclosing, retaining, and displaying documents, artistic designs, miscellaneous papers, fabric swatches, or other sheet material of various quantity and thickness; said device including:
a) an outer binder having a front cover and a back cover;
b) said front and back covers being joined to each other by a flexible spine member;
c) a retaining strap mounted within and between said front and back covers for holding selected quantities of sheet material therein; said retaining strap being adjustable to accommodate various quantities of material within;
d) said retaining strap further including:
i) a base member formed of flexible material of uniform width and thickness;
ii) a head portion formed integrally to one end of said base member;
iii) a terminal end integral to said base and opposite said head portion;
iv) an aperture of selected shape and size formed in said head portion, for receiving said terminal end therethrough;
v) a plurality of rounded knobs protruding perpendicularly from one side of said base member, spaced equidistantly from each other between said head portion and said terminal end;
iv) a selected one of said knobs locking into said aperture, when said terminal end is inserted through said aperture;
for retaining the sheet material therein; whereby said terminal end is inserted through said head portion and a selected one of said knobs locked into said aperture, to hold material therein.

2. A device according to claim 1 and further including: each of said knobs on said retaining strap including side walls extending vertically from said base member; and a locking notch formed in said side walls for engaging at least one edge of said aperture in said knob.

3. A device according to claim 1 wherein said flexible spine member is integral to said front and back covers, and includes a plurality of scored indents formed therein for improving flexibility; said scored indents being spaced apart, parallel to each other and to adjoined edges of said front and back covers.

4. A device according to claim 1 wherein said flexible spine member is separable from said front and back covers; said flexible spine member being formed of a plicated material which may be selectively expanded or contracted to accommodate various thicknesses of material therein; said plicated material having means for securing to said front and back covers, to form said outer binder of said device.

5. A device according to claim 4 wherein said means for securing said plicated material to said front and back covers further includes a shoulder means positioned between said flexible spine and each of said front and back covers, for strengthening the joints between said front and back covers; and a plurality of slots formed in each shoulder means for receiving said retaining straps therethrough.
